(19) United States
(12) Patent Application Publication
(10) Pub. No.: US 2023/0224674 A1
(43) Pub. Date: Jul. 13, 2023

(54) METHOD, APPARATUS AND COMPUTER PROGRAM FOR DETERMINATING MOBILITY USER'S MOVEMENT PATTERN USING ARTIFICIAL INTELLIGENCE

(71) Applicant: Nei & Company Inc., Seoul (KR)

(72) Inventor: Sung Bo SHIM, Seoul (KR)

(73) Assignee: Nei & Company Inc., Seoul (KR)

(21) Appl. No.: 18/071,628

(22) Filed: Nov. 30, 2022

(30) Foreign Application Priority Data
Jan. 11, 2022 (KR) 10-2022-0004235

(51) Int. Cl. H04W 4/029; H04W 4/40

(52) U.S. Cl. CPC H04W 4/029; H04W 4/40

(57) ABSTRACT

Provided is a method for determining a mobility user's movement pattern using artificial intelligence, the method being performed by a computing device and including: acquiring movement data of the computing device that the user taking a transportation means carries; and acquiring a type of the transportation means by using an artificial intelligence model trained with the movement data.

### CROSS REFERENCE TO RELATED APPLICATION

The present application claims priority to Korean Patent Application No. 10-2022-0004235, filed Jan. 11, 2022, the entire contents of which is incorporated herein for all purposes by this reference.

### BACKGROUND OF THE INVENTION

### Field of the Invention

The present disclosure relates to a method, an apparatus, and a computer program for determining a mobility user's movement pattern using artificial intelligence.

### Description of the Related Art

Mobility as a Service (MaaS) means a means of transportation as a service, and is a service that provides an optimal route to a user by integrating information on transportation means, such as buses, taxis, subways, etc.

MaaS provides arrival information and a reservation service about various means of transportation to a user who wants to move from a departure point to an arrival point. In order to provide a perfect MaaS, it is necessary to accurately understand a mobility user's movement pattern, such as a user's locations, movement path, information on whether the user has boarded or alighted from a means of mobility, points in time when the user boards or alights, etc.

A conventional apparatus for determining a mobility user's movement pattern has a problem of high battery consumption because in the background of an application, location data is collected using GPS at particular time intervals and data is transmitted to and received from a server.

In addition, a large error occurs in a tunnel or under the ground where GPS measurement is difficult, and it is difficult to determine a type of a transportation means being taken with the location data collected using GPS.

As an alternative to the above problem, attempts have been made to use tag payment or credit card payment information for using public transportation means. However, in general, payment information is retrospectively analyzed, so it is difficult to analyze a user's movement pattern in real time.

In addition, in many cases, tag payment is made only when boarding buses or a subways and tag payment is not made when alighting. Regarding the taxis, card payment is made only when alighting. Therefore, this makes real-time analysis of a user's movement pattern difficult. In addition, payment information is distributed among many card companies, so it is practically difficult to use all pieces of the payment information.

The foregoing is intended merely to aid in the understanding of the background of the present disclosure, and is not intended to mean that the present disclosure falls within the purview of the related art that is already known to those skilled in the art.

### Document of Related Art

(Patent Document 1) Korean Patent No. 10-2278941

### SUMMARY OF THE INVENTION

Embodiments of the present disclosure are directed to providing a method, an apparatus, and a computer program for determining a mobility user's movement pattern using artificial intelligence, the method, the apparatus, and the computer program being capable of minimizing battery consumption with the minimized use of GPS.

Embodiments of the present disclosure are directed to providing a method, an apparatus, and a computer program for determining a mobility user's movement pattern using artificial intelligence, the method, the apparatus, and the computer program being capable of determining a user's movement pattern in real time.

According to an embodiment of the present disclosure, there is provided a method for determining a mobility user's movement pattern using artificial intelligence, the method being performed by a computing device and including: acquiring movement data of the computing device that the user taking a transportation means carries; and acquiring a type of the transportation means by using an artificial intelligence model trained with the movement data.

In various embodiments, the movement data of the computing device may include at least one selected from a group of acceleration data, angular velocity data, motion data, and step count data.

In various embodiments, the transportation means may include at least one selected from a group of a bus, a subway, a bicycle, an e-scooter, a car, and walking.

In various embodiments, the method may further include: after the acquiring of the movement data, transmitting the movement data to an internal server; and receiving the artificial intelligence model trained with the movement data from the internal server.

In various embodiments, the method may further include: determining whether the type of the transportation means has changed; acquiring location data of the computing device when it is determined that the changed transportation means is a non-walking transportation means; and acquiring a movement path of the computing device by using the location data of the computing device.

In various embodiments, the acquiring of the location data of the computing device when it is determined that the changed transportation means is the non-walking transportation means may include acquiring the location data of the computing device at first time intervals.

In various embodiments, the acquiring of the location data of the computing device when it is determined that the changed transportation means is the non-walking transportation means may further include acquiring the location data of the computing device at second time intervals longer than the first time intervals when it is determined that the changed transportation means is walking.

In various embodiments, the acquiring of the type of the transportation means by using the artificial intelligence model trained with the movement data may include: extracting a feature value of the movement data by using the artificial intelligence model trained with the movement data; extracting a probability value for the type of the transportation means on the basis of the feature value of the movement data; and acquiring the type of the transportation means on the basis of the probability value for the type of the transportation means.

In various embodiments, the extracting of the feature value of the movement data by using the artificial intelligence model trained with the movement data may include: generating a graph image of which one axis represents values of the movement data and another axis represents time when the movement data is acquired; dividing the graph image into unit frame images on the basis of a preset time period; and extracting the feature value of the movement data by using the trained artificial intelligence model for the unit frame images.

In various embodiments, the method may further include: determining whether the type of the transportation means has changed; and acquiring a transportation time period of each of the transportation means on the basis of a time point of changing the transportation means.

In various embodiments, the method may further include: determining whether the type of the transportation means has changed; acquiring location data of the computing device when it is determined that the changed transportation means is a non-walking transportation means; acquiring location data of a stop of the non-walking transportation means; and determining whether the user has boarded or alighted from the non-walking transportation means, on the basis of the location data of the computing device and the location data of the stop.

In various embodiments, the transmitting of the movement data to the internal server may include transmitting the movement data, and a type value of the transportation means when the movement data is sensed to the internal server, wherein the artificial intelligence model may be trained with the movement data and the type value of the transportation means with which the movement data is labeled.

According to an embodiment of the present disclosure, there is provided an apparatus for determining a mobility user's movement pattern using artificial intelligence, the apparatus including: a processor; a network interface; a memory; and a computer program loaded into the memory and executed by the processor, wherein the computer program may include: an instruction for acquiring movement data of the user taking a transportation means; and an instruction for acquiring a type of the transportation means by using an artificial intelligence model trained with the movement data.

According to an embodiment of the present disclosure, there is provided a computer program for determining a mobility user's movement pattern using artificial intelligence, the computer program being combined with a computing device and being stored on a computer-readable recording medium to execute: acquiring movement data of the computing device that the user taking a transportation means carries; and acquiring a type of the transportation means by using an artificial intelligence model trained with the movement data.

The embodiments of the present disclosure can provide the method, the apparatus, and the computer program for determining a mobility user's movement pattern using artificial intelligence, the method, the apparatus, and the computer program being capable of minimizing battery consumption with the minimized use of GPS.

The embodiments of the present disclosure can provide the method, the apparatus, and the computer program for determining a mobility user's movement pattern using artificial intelligence, the method, the apparatus, and the computer program being capable of determining a user's movement pattern in real time.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating a system for determining a mobility user's movement pattern using artificial intelligence according to an embodiment of the present disclosure;

FIG. 2 is a hardware configuration diagram illustrating an apparatus for determining a mobility user's movement pattern using artificial intelligence according to an embodiment of the present disclosure;

FIG. 3 is a hardware configuration diagram illustrating an internal server connected in communication to an apparatus for determining a mobility user's movement pattern using artificial intelligence according to an embodiment of the present disclosure;

FIG. 4 is a flowchart illustrating a method for determining a mobility user's movement pattern using artificial intelligence according to an embodiment of the present disclosure;

FIG. 5 is a flowchart illustrating a method of acquiring an artificial intelligence model according to an embodiment of the present disclosure;

FIG. 6 is a flowchart illustrating a method of training an artificial intelligence model with movement data, in various embodiments;

FIG. 7 is a flowchart illustrating a method of acquiring a type of a transportation means being taken by a user, in various embodiments;

FIG. 8 is a diagram illustrating examples of graphs generated by an apparatus for determining a mobility user's movement pattern using artificial intelligence, in various embodiments;

FIG. 9 is a diagram illustrating a concept of classifying a type of a transportation means being taken by a user, in various embodiments;

FIG. 10 is a diagram illustrating examples of transportation means usable for moving from point A to point B;

FIG. 11 is a flowchart illustrating a method of acquiring a movement path of a transportation means by using location data of a computing device as a method of determining a user's movement pattern, in various embodiments;

FIG. 12 is a flowchart illustrating a method of acquiring a transportation time period of a transportation means as a method of determining a user's movement pattern, in various embodiments;

FIG. 13 is a flowchart illustrating a method of determining whether a user has boarded or alighted from a non-walking transportation means by using location data of a stop as a method of determining a user's movement pattern, in various embodiments; and

FIG. 14 is an overall conceptual diagram illustrating a system for determining a mobility user's movement pattern using artificial intelligence according to an embodiment of the present disclosure.

### DETAILED DESCRIPTION OF THE INVENTION

Embodiments of the present disclosure may have a variety of modifications, so the embodiments are illustrated in the drawings and described in detail herein. However, this is not intended to limit the embodiments of the present disclosure to specific forms, and the embodiments include all modifications, equivalents, or substitutes in a technical concept and a technical scope of the present disclosure.

The terms used herein are provided to describe the embodiments but not to limit the present disclosure. In the specification, the singular forms include plural forms unless particularly mentioned. The terms “comprises” and/or “comprising” used herein specify the presence of stated elements, but do not preclude the presence or addition of one or more other elements. Throughout the specification, the same reference numerals will refer to the same elements. The term “and/or” includes any and all combinations of one or more of the associated listed elements. The terms “first”, “second”, etc. may be used to describe various elements, but these elements are not limited by these terms. These terms are only used to distinguish one element from another element. Accordingly, a first element described below could be termed a second element without departing from the technical idea of the present disclosure.

Unless defined otherwise, all terms (including technical and scientific terms) used herein have the same meaning as commonly understood by those skilled in the art to which the present disclosure belongs. Further, unless explicitly defined otherwise, the terms defined in a generally-used dictionary are not ideally or excessively interpreted.

The team “unit” or “module” used in the specification means a software element or hardware element such as an FPGA or an ASIC, and performs a specific function. However, the term “unit” or “module” is not limited to software or hardware. The term “unit” or “module” may be formed so as to be in an addressable storage medium, or may be formed so as to operate one or more processors. Thus, for example, the term “unit” or “module” may refer to elements such as software elements, object-oriented software elements, class elements, and task elements, and may include processes, functions, attributes, procedures, subroutines, segments of program code, drivers, firmware, micro codes, circuits, data, a database, data structures, tables, arrays, and variables. A function provided in the elements and “units” or “modules” may be associated with the smaller number of elements and “units” or “modules”, or may be divided into additional elements and “units” or “modules”.

Spatially relative terms, such as “below”, “beneath”, “lower”, “above”, “upper”, etc., may be used herein to easily describe a relation between one element and other elements as shown in the drawings. It will be understood that the spatially relative terms are intended to encompass different orientations of the elements in user or operation in addition to the orientations depicted in the drawings. For example, if an element shown in the drawings is turned over, elements described as “below” or “beneath” other elements may then be oriented “above” the elements. Thus, the term “below” can encompass both orientations “above” and “below”. The elements may be otherwise oriented and the spatially relative descriptors used herein may be interpreted accordingly.

Hereinafter, embodiments of the present disclosure will be described in detail with reference to the accompanying drawings.

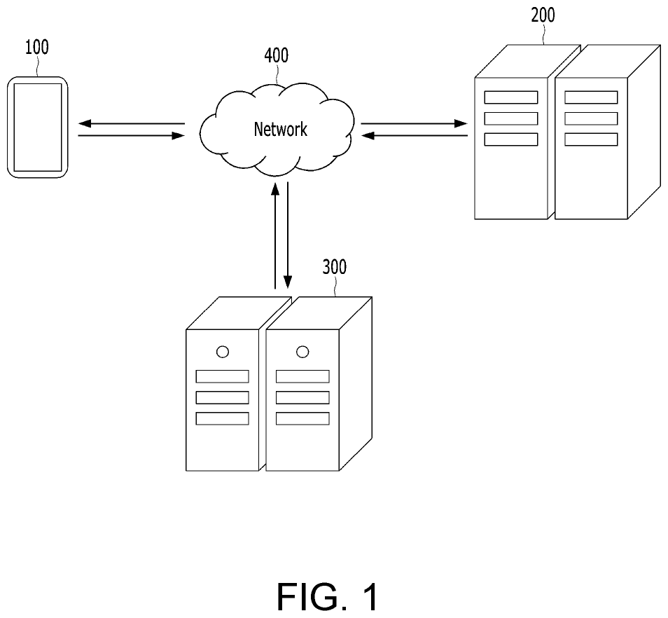

FIG. 1 is a diagram illustrating a system for determining a mobility user's movement pattern using artificial intelligence according to an embodiment of the present disclosure.

Referring to FIG. 1, the system for determining a mobility user's movement pattern using artificial intelligence according to the embodiment of the present disclosure may include an apparatus 100 for determining a mobility user's movement pattern, an internal server 200, and an external server 300.

The system for determining a mobility user's movement pattern using artificial intelligence according to the embodiment of the present disclosure shown in FIG. 1 is merely an embodiment, and elements thereof are not limited to those of the embodiment shown in FIG. 1, and may be added, changed, or deleted as necessary.

In an embodiment, the apparatus 100 for determining a mobility user's movement pattern is a computing device 100 that the user taking transportation means carries. The apparatus 100 may acquire movement data of the user, and may acquire types of the transportation means by using an artificial intelligence model trained with the movement data. For example, the apparatus 100 for determining a mobility user's movement pattern may use the movement data and the trained artificial intelligence model to classify a type of a transportation means being taken by the user, wherein the movement data includes at least one selected from the group of acceleration data, angular velocity data, motion data, and step count data. However, no limitation thereto is imposed.

In addition, the apparatus 100 for determining a mobility user's movement pattern may be connected to the internal server 200 in communication over a network 400. The apparatus 100 may provide the movement data to the internal server 200 that trains the artificial intelligence model with the movement data, and may receive the trained artificial intelligence model from the internal server 200.

In addition, when acquiring the types of the transportation means, the apparatus 100 for determining a mobility user's movement pattern may start acquiring location data or make a period of acquisition of the location data shorter or longer according to the transportation means, thereby acquiring a movement path of the user based on the location data.

In addition, when acquiring the types of the transportation means, the apparatus 100 for determining a mobility user's movement pattern may acquire a transportation time period of each transportation means taken by the user, on the basis of time points of changing the transportation means.

In addition, when acquiring the types of the transportation means, the apparatus 100 for determining a mobility user's movement pattern may acquire location data of stops of the transportation means, and may use the types of the transportation means and the location data of the stops to acquire whether the user has boarded or alighted from each transportation means and time points of boarding or alighting.

In addition, the apparatus 100 for determining a mobility user's movement pattern may acquire information on the transportation means taken on a path from a departure point to an arrival point, the types of the transportation means, a transportation time period of each transportation means, and time points of boarding or alighting from each transportation means.

In addition, the apparatus 100 for determining a mobility user's movement pattern may provide the external server 300 with at least one of the following data: data on a type of each transportation means taken by the user, data on a transportation time period of each transportation means, data on whether the user has boarded or alighted from each transportation means, data on time points of boarding or alighting from each transportation means, and data on a movement path of the user or a transportation means. The apparatus 100 may store and manage the data in the external server 300.

In an embodiment, the internal server 200 may be connected in communication over the network 400 to the apparatus 100 for determining a mobility user's movement pattern, may receive movement data, may train an artificial intelligence model with the movement data, and may provide the trained artificial intelligence model to the apparatus 100 for determining a mobility user's movement pattern.

In an embodiment, the external server 300 may be connected in communication over the network 400 to the apparatus 100 for determining a mobility user's movement pattern, and may receive, from the apparatus 100 for determining a mobility user's movement pattern, information on the movement pattern of the user taking a transportation means and may store the information therein. For example, the external server 300 may be an external storage server for storing and managing a large amount of data, but is not limited thereto.

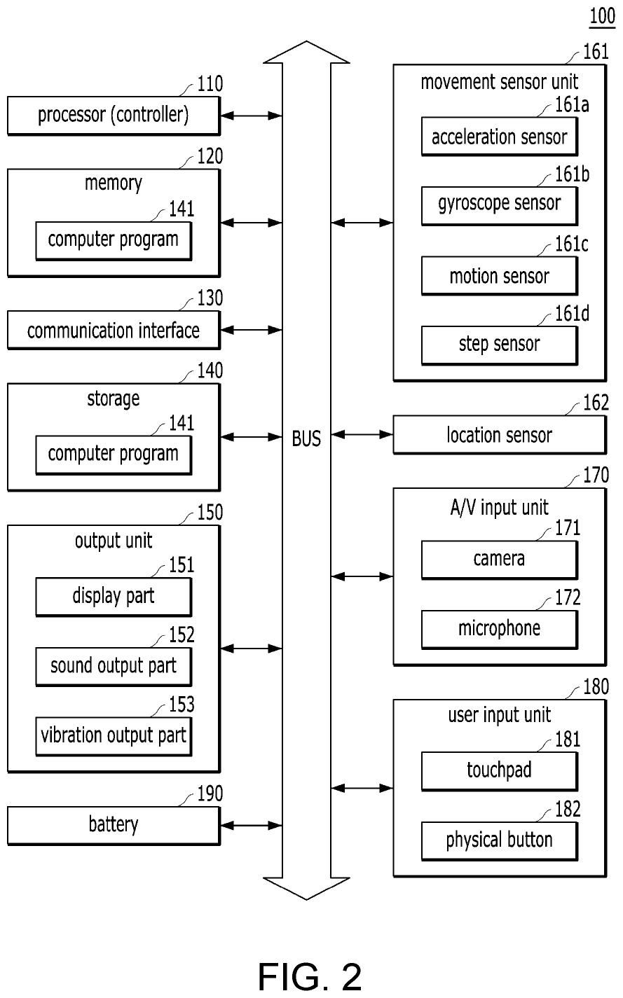

Hereinafter, a hardware configuration of the apparatus 100 for determining a mobility user's movement pattern will be described with reference to FIG. 2, wherein the apparatus 100 performs a method for determining a mobility user's movement pattern using artificial intelligence.

FIG. 2 is a hardware configuration diagram illustrating an apparatus for determining a mobility user's movement pattern using artificial intelligence according to an embodiment of the present disclosure.

Referring to FIG. 2, the apparatus 100 for determining a mobility user's movement pattern using artificial intelligence (hereinafter, referred to as a “computing device 100”) according to the embodiment of the present disclosure may include at least one processor 110, a memory 120 into which a computer program 141 executed by the processor 110 is loaded, a communication interface 130, and a storage 140 in which the computer program 141 is stored.

Herein, FIG. 2 shows elements related to an embodiment of the present disclosure. Therefore, those skilled in the art to which the present disclosure pertains will appreciate that other general-purpose elements may be further included in addition to the elements shown in FIG. 2.

In various embodiments, in this specification, the computing device 100 refers to all types of hardware devices including the at least one processor 110. According to the embodiments, the computing device 100 may be understood as encompassing a software configuration operating in a hardware device corresponding thereto. For example, it will be understood that examples of the computing device 100 include a smartphone, a tablet PC, a desktop computer, a laptop computer, and a user client and an application running on each device, but are not limited thereto. Although each step described in this specification is described as being performed by the computing device 100, the subject of each step is not limited to the computing device 100. According to the embodiments, at least part of each step may be performed in different devices.

The processor 110 controls overall operation of each element of the computing device 100. The processor 110 may include a central processing unit (CPU), a microprocessor unit (MPU), a microcontroller unit (MCU), a graphics processing unit (GPU), or any type of processor well known in the art.

In addition, the processor 110 may perform operation of at least one application or program for performing a method according to the embodiments of the present disclosure. The computing device 100 may include at least one processor.

In addition, the processor 110 may further include random-access memory (RAM, not shown) and read-only memory (ROM, not shown) in which signals (or data) processed in the processor 110 are stored temporarily and/or permanently. In addition, the processor 110 may be implemented in the form of a system-on-chip (SoC) including at least one of the following: a graphics processing unit, RAM, and ROM.

The memory 120 stores therein various types of data, commands, and/or information. The memory 120 may load the computer program 141 from the storage 140 to perform a method/operation according to various embodiments of the present disclosure. When the computer program 141 is loaded into the memory 120, the processor 110 may perform the method/operation by executing at least one instruction constituting the computer program 141. The memory 120 may be implemented as a volatile memory such as RAM, but the technical scope of the present disclosure is not limited thereto.

The bus provides a communication function between the elements of the computing device 100. The bus may be implemented in various forms, such as an address bus, a data bus, and a control bus.

The communication interface 130 supports wired or wireless Internet communication of the computing device 100. In addition, the communication interface 130 may support various communication methods other than Internet communication. For example, the communication interface 130 may support at least one of the following: short-range communication, mobile communication, and broadcast communication. To this end, the communication interface 130 may include a communication module well known in the art. In some embodiments, the communication interface 130 may be omitted.

The storage 140 may store therein the computer program 141 non-temporarily. The storage 140 may include non-volatile memory, such as read-only memory (ROM), erasable programmable ROM (EPROM), electrically erasable programmable ROM (EEPROM), flash memory, etc., a hard disk, a removable disk, or any type of computer-readable recording medium well known in the art.

The computer program 141 may include the at least one instruction that makes the processor 110 perform the method/operation according to various embodiments of the present disclosure when the computer program 141 is loaded into the memory 120. That is, the processor 110 may perform the method/operation according to various embodiments of the present disclosure by executing the at least one instruction.

In an embodiment, the computer program 141 may include: an instruction for acquiring movement data of the user taking a transportation means; and an instruction for acquiring a type of the transportation means by using an artificial intelligence model trained with the movement data.

The storage 140 may non-temporarily store therein at least one of the following: movement data sensed by a movement sensor unit 161, location data of the user or the computing device 100 sensed by a location sensor 162, and location data of a stop of a non-walking transportation means. In addition, the storage 140 may store therein a program (or application) related to the trained artificial intelligence model.

Steps of a method or an algorithm described in relation to an embodiment of the present disclosure may be directly implemented in hardware, implemented in a software module executed by hardware, or implemented by a combination thereof. The software module may reside in random-access memory (RAM), read-only memory (ROM), erasable programmable ROM (EPROM), electrically erasable programmable ROM (EEPROM), flash memory, a hard disk, a removable disk, CD-ROM, or any type of computer-readable recording medium well known in the art.

In an embodiment, the computer program 141 may be a computer program for determining a mobility user's movement pattern using artificial intelligence, wherein the computer program is combined with the computing device 100 and stored on a computer-readable recording medium to execute: acquiring movement data of the computing device 100 that the user taking a transportation means carries; and acquiring a type of the transportation means by using an artificial intelligence model trained with the movement data.

The elements of the present disclosure may be implemented as a program (or application) to be executed in combination with a computer, which is hardware, and may be stored in a medium. The elements of the present disclosure may be implemented as software programming or software elements. Similarly, the embodiments may be implemented in programming or scripting languages, such as C, C++, Java, assembler, etc., including various algorithms implemented as combinations of data structures, processes, routines, or other programing elements. Functional aspects may be implemented as algorithms running on at least one processor.

Furthermore, the computing device 100 may further include at least one of the following: an output unit 150, the movement sensor unit 161, the location sensor 162, an A/V input unit 170, a user input unit 180, and a battery 190.

The output unit 150 may output at least one of the following: a video signal, an audio signal, and a vibration signal, which are generated or executed by a program (or application) in operation. The output unit 150 may include at least one of the following: a display part 151 for outputting a video signal, a sound output part 152 for outputting an audio signal, and a vibration output part 153 for outputting a vibration signal.

A sensing unit (not shown) may sense a state of the computing device 100 or a state near the computing device 100, and may store the sensed data and/or information in the storage 140 or transmit the same to the processor 110.

The sensing unit (not shown) may include the movement sensor unit 161 for detecting a state of the computing device 100 moving, and the location sensor 162 for sensing a location of the computing device 100. The movement sensor unit 161 may include at least one of the following: an acceleration sensor 161a, a gyroscope sensor 161b, a motion sensor 161c, and a step sensor 161d. The location sensor 162 may include GPS. Furthermore, the sensing unit (not shown) may further include at least one of the following: a magnetic sensor, a temperature/humidity sensor, an infrared sensor, a barometric pressure sensor, a proximity sensor, and an RGB sensor. A person skilled in the art can intuitively infer a function of each sensor from its name, so a detailed description thereof will be omitted.

The audio/video (A/V) input unit 170 is for inputting an external audio signal or video signal to the computing device 100, and may include a camera 171 and a microphone 172. The camera 171 may obtain image frames, such as still images or videos, through an image sensor in a video call mode or a shooting mode. The microphone 172 may receive external sound signals and process the same into electrical sound data and store the electrical sound data.

The user input unit 180 refers to a means for the user to input a user input signal or data for controlling the computing device 100. The user input unit 180 may include a touchpad 181 (for example, a contact capacitance type, a pressure resistive film type, an infrared sensing type, a surface ultrasonic conduction type, an integral strain measurement type, a piezo effect type, etc.) and a physical button 182, such as a keypad, a power button, a volume button, etc., but is not limited thereto. In the meantime, the touchpad 181 may be a touchscreen integrated with the display part 151.

The battery 190 may have a capacity of a particular size, may be wired or wireless charged, and may provide power to each of the elements of the computing device 100.

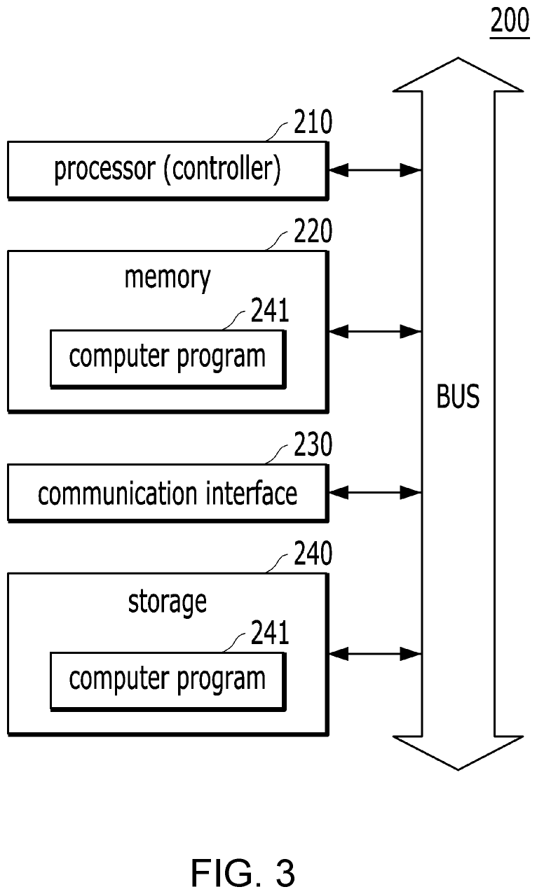

Hereinafter, a hardware configuration of the internal server 200 will be described with reference to FIG. 3, wherein the internal server 200 performs a method for determining a mobility user's movement pattern using artificial intelligence.

FIG. 3 is a hardware configuration diagram illustrating an internal server connected in communication to an apparatus for determining a mobility user's movement pattern using artificial intelligence according to an embodiment of the present disclosure.

Referring to FIG. 3, the internal server 200 according to an embodiment of the present disclosure may include at least one processor 210, a memory 220 into which a computer program 241 executed by the processor 210 is loaded, a communication interface 230, and a storage 240 in which the computer program 241 is stored.

The respective descriptions of the processor 110, the memory 120, the communication interface 130, and the storage 140 of the computing device 100 may be applied to the processor 210, the memory 220, the communication interface 230, and the storage 240 of the internal server 200 as they are, so a redundant description will be omitted.

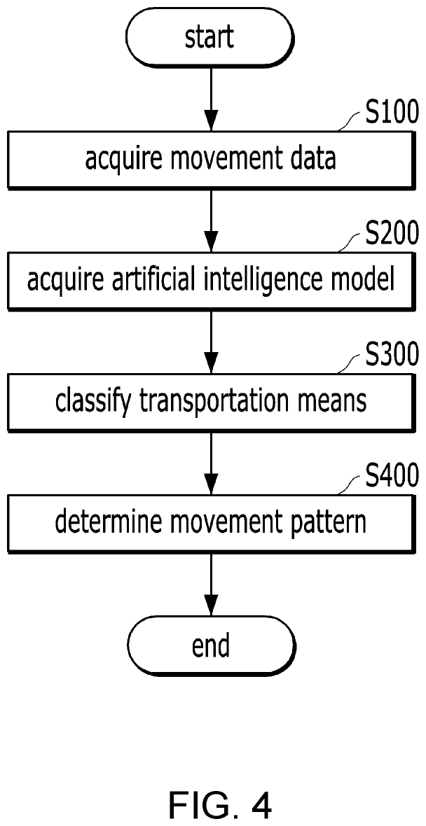

Hereinafter, a method for determining a mobility user's movement pattern using artificial intelligence will be described with reference to FIG. 4, wherein the method is performed by the computing device 100.

FIG. 4 is a flowchart illustrating a method for determining a mobility user's movement pattern using artificial intelligence according to an embodiment of the present disclosure.

Referring to FIG. 4, in step S100, the computing device 100 may acquire movement data of the computing device 100 that the user taking a transportation means carries. In step S200, the computing device 100 may acquire an artificial intelligence model trained to acquire a type of the transportation means. In step S300, the computing device 100 may classify the transportation means by using the artificial intelligence model trained with the movement data. In step S400, the computing device 100 may determine a movement pattern of the user by using the acquired type of the transportation means.

In various embodiments, types of transportation means may include at least one of the following: a bus, a subway, a bicycle, an e-scooter, a car, and walking. A non-walking transportation means refer to a device or mechanism that is capable of reaching a higher speed than walking among the transportation means and allows the user to ride. For example, the non-walking transportation means include at least one of the following: a bus, a subway, a bicycle, an e-scooter, and a car.

In step S100, the computing device 100 may use the movement sensor unit 161 to collect movement data of the user who is moving taking a transportation means. In addition, the computing device 100 may collect the movement data of the user who is moving taking a non-walking transportation means, walking, or stopped.

Herein, the movement data of the computing device 100 may include at least one of the following: acceleration data detected by the acceleration sensor 161a, angular velocity data detected by the gyroscope sensor 161b, motion data detected by the motion sensor 161c, and step count data detected by the step sensor 161d. However, without being limited thereto, the movement data of the computing device 100 may include various types of data capable of determining a state of the user's movement.

In various embodiments, the computing device 100 may collect one or a combination of at least two simultaneously selected from the group of the acceleration data, the angular velocity data, the motion data, and the step count data. The computing device 100 may collect the movement data as well as time point data on sensing the movement data.

In various embodiments, the computing device 100 may collect the movement data of the user at preset first movement time intervals. For example, the computing device 100 may collect the movement data of the user at first movement time intervals of 1 second.

In step S200, the computing device 100 may acquire an artificial intelligence model. The computing device 100 may receive a trained artificial intelligence model from the internal server 200, or may train and generate an artificial intelligence model by itself. In FIG. 4, step S200 follows step S100, but without being limited thereto, may precede step S100.

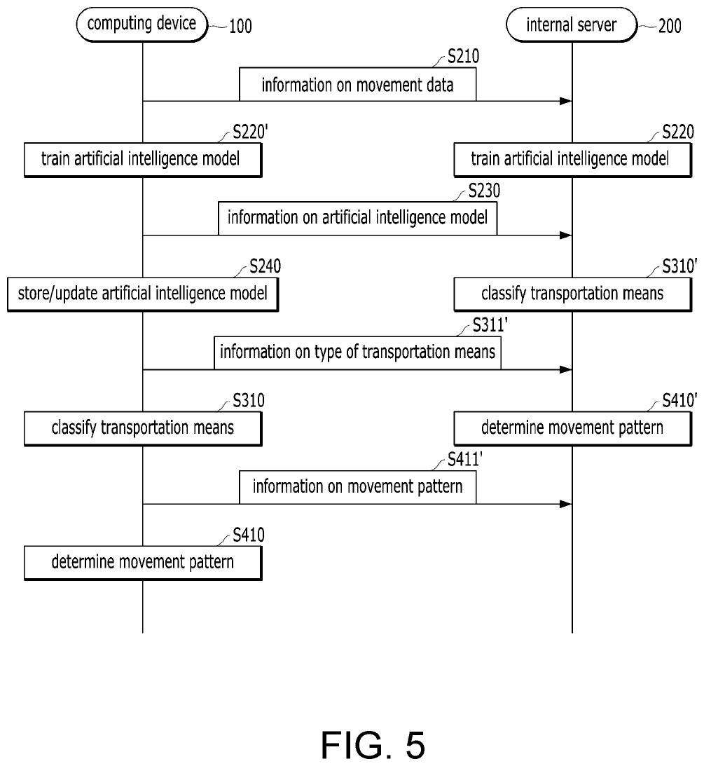

Hereinafter, a method in which the computing device 100 acquires the artificial intelligence model will be described with reference to FIG. 5.

FIG. 5 is a flowchart illustrating a method of acquiring an artificial intelligence model according to an embodiment of the present disclosure.

In step S210, after the step S100 of acquiring the movement data, the computing device 100 may transmit information on the movement data to the internal server 200. The information on the movement data may include the movement data detected by the movement sensor unit 161 of the computing device 100 and time point data on detecting the movement data.

Furthermore, the information on the movement data may include the movement data detected by the movement sensor unit 161 of the computing device 100, the time point data on detecting the movement data, and type data of the transportation means that the user is taking at the time point of detecting the movement data.

In step S220, the internal server 200 may receive and store the information on the movement data, may set the information on the movement data as training data, may use the training data to train an artificial intelligence model, and may store the trained artificial intelligence model.

Herein, the artificial intelligence model includes at least one network function, and the at least one network function may include a set of interconnected units of computation which may be generally referred to as “nodes”. The “nodes” may also be referred to as “neurons”. The at least one network function include one or more nodes. The nodes (or neurons) constituting the at least one network function may be interconnected via one or more “links”.

In the artificial intelligence model, the one or more nodes connected to each other via the links may form a relative relation between an input node and an output node. The concept of the input node and the output node is relative. Any node that is an output node for one node may be an input node for another node, and vice versa. As described above, a relation between an input node and an output node may be created with a link therebetween. At least one output node may be connected to one input node via a link, and vice versa.

In a relation between an input node and an output node connected to each other via one link, a value of the output node may be determined on the basis of data input to the input node. Herein, a node interconnecting the input node and the output node may have a weight. A weight may be variable, and may be varied by a user or an algorithm in order to perform a function that the artificial intelligence model wants. For example, when one or more input nodes are interconnected to one output node via respective links, the output node may determine an output node value on the basis of values input to the input nodes connected to the output node and the weights set to the links corresponding to the respective input nodes.

As described above, in the artificial intelligence model, one or more nodes are interconnected via one or more links and form a relation between an input node and an output node. Characteristics of the artificial intelligence model may be determined according to the number of nodes and links, relations between the nodes and the links, and a value of a weight assigned to each of the links within the artificial intelligence model. For example, when there are artificial intelligence models having the same number of nodes and links and different weight values between the links, the two artificial intelligence models may be recognized as different from each other.

Some of the nodes constituting the artificial intelligence model may form one layer on the basis of distances from an initial input node. For example, a set of nodes having a distance of n from the initial input node may form layer n. The distance from the initial input node may be defined by the minimum number of links, which need to be passed to reach a corresponding node from the initial input node. However, the definition of the layer is merely an example for description, and a degree of layer within the artificial intelligence model may be defined by a different method from the foregoing method. For example, a layer of nodes may be defined by a distance from a final output node.

The initial input node may mean one or more nodes to which data is directly input without passing a link in a relation to other nodes among the nodes within the artificial intelligence model. Alternatively, the initial input node may mean nodes having no other input nodes connected via links in a relation between nodes with links therebetween within the artificial intelligence model network. Similarly, the final output node may mean one or more nodes having no output node in a relation to other nodes among the nodes within the artificial intelligence model. In addition, hidden nodes may mean nodes constituting the artificial intelligence model other than the initial input nodes and the final output nodes. An artificial intelligence model according to an embodiment of the present disclosure may be an artificial intelligence model in which the number of nodes of an input layer may be greater than the number of nodes of a hidden layer close to an output layer and the number of nodes decreases as it goes from the input layer to the hidden layer.

The artificial intelligence model may include at least one hidden layer. The hidden nodes of the hidden layers may use outputs of previous layers and outputs of nearby hidden nodes as inputs. The number of hidden nodes for each of the hidden layers may be the same or different. The number of nodes of the input layer may be determined on the basis of the number of data fields of input data, and may be the same as or different from the number of hidden nodes. The input data input to the input layer may be calculated by the hidden nodes of the hidden layers and may be output by a fully connected layer (FCL) that is the output layer.

Hereinafter, described will be a method in which the movement data is set as the training data and the training data is used to train the artificial intelligence model.

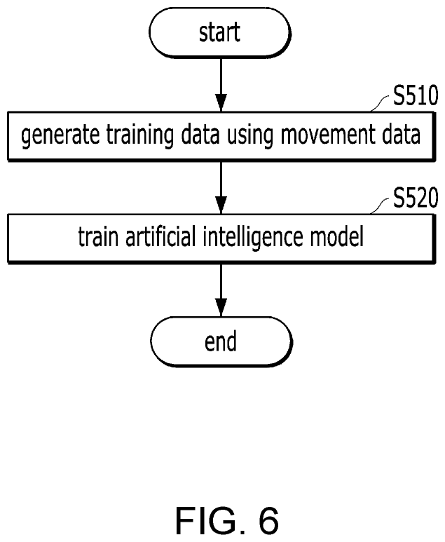

FIG. 6 is a flowchart illustrating a method of training an artificial intelligence model with movement data, in various embodiments.

Referring to FIG. 6, in step S510, the internal server 200 may use the movement data to generate the training data for training the artificial intelligence model.

For example, the internal server 200 may generate the training data using the movement data collected by the computing device 100 and the time point data on collecting the movement data.

As another example, the internal server 200 may generate the training data by labeling the movement data collected by the computing device 100 and the time point data on collecting the movement data with the type data of the transportation means at the time of collecting the movement data. However, no limitation thereto is imposed.

Herein, the computing device 100 may provide a user interface (UI) for collecting the movement data to the user who is taking a transportation means, and may obtain, through the UI, user input on a time point when to generate the training data or stop generating the training data. In addition, while collecting the movement data corresponding to the user input, the computing device 100 may obtain user input on the type of the transportation means that the user is taking. In addition, the computing device 100 may provide the internal server 200 with information on the movement data and the time point data on collecting the movement data. Alternatively, computing device 100 may label the movement data and the time point data on collecting the movement data with information on the type data of the transportation means, and may provide a result of labeling to the internal server 200. However, no limitation thereto is imposed.

In step S520, the internal server 200 may train the artificial intelligence model with the training data generated in step S510.

The internal server 200 may use a training data set to train at least one network function constituting the artificial intelligence model.

In an embodiment, the internal server 200 may input each training input data set into the at least one network function, may extract output data values calculated with the at least one network function as feature values, may use the extracted feature values to extract a probability value for each transportation means, and may compare the extracted probability values (or feature values) with training input data, thereby training the artificial intelligence model. Herein, a training input data set may be at least one of the following: a graph image of which one axis represents values of movement data and another axis represents time when the movement data is acquired; unit frame images obtained by dividing the graph image on the basis of a preset time period; the movement data; and time point data itself on acquiring the movement data.

In another embodiment, the internal server 200 may input each training input data set into the at least one network function, and may derive an error by comparing each piece of output data calculated by the at least one network function with each training output data set corresponding to a label of each training input data set. Herein, a training input data set may be a data set resulting from labeling, with a type value of a transportation means when the movement data is sensed, at least one of the following: a graph image of which one axis represents values of movement data and another axis represents time when the movement data is acquired; unit frame images obtained by dividing the graph image on the basis of a preset time period; the movement data; and time point data itself on acquiring the movement data.

In training of the artificial intelligence model, training input data may be input to the input layer of the at least one network function, and training output data may be compared with output of the at least one network function. The internal server 200 may train the artificial intelligence model on the basis of an error between an operation result of the at least one network function for the training input data and the training output data (label).

In addition, the internal server 200 may use the error to adjust weights of the at least one network function in a backpropagation manner. That is, the internal server 200 may use the error between the operation result of the at least one network function for the training input data and the training output data to adjust the weights such that the output of the at least one network function approaches the training output data.

When training of the at least one network function is performed for predetermined epochs or more, the internal server 200 may use validation data to determine whether to stop training. The predetermined epochs may be part of a total of training target epochs. The validation data may be at least part of a labeled training data set. That is, the computing device 100 may use the training data set to train the artificial intelligence model. After training of the artificial intelligence model is repeated for predetermined epochs or more, the computing device 100 may use the validation data to determine whether the effect of training of the artificial intelligence model is equal to or greater than a predetermined level. For example, when performing training with 100 pieces of training data and with the target number of training repetitions of 10, the internal server 200 performs training 10 times, which is predetermined epochs, and then performs training three times with 10 pieces of validation data. When a change in output of the artificial intelligence model is equal to or below a predetermined level during the three repetitions of training, it is determined that further training is meaningless and training may be terminated. That is, the validation data may be used to determine completion of training on the basis of whether the effect of training per epoch in repeated training of the artificial intelligence model is equal to or greater than a predetermined level or less. The numbers of pieces of training data and validation data, and the number of repetitions described above are merely examples, and are not limited thereto.

The internal server 200 may use a test data set to test the at least one network function for performance to determine whether to activate the at least one network function, thereby generating the artificial intelligence model. Test data may be used to measure the performance of the artificial intelligence model, and may be at least part of the training data set. For example, 70% of the training data set may be used for training of the artificial intelligence model (that is, training to adjust the weights so that result values similar to the labels are output), and 30% of the training data set may be used as test data for measuring the performance of the artificial intelligence model.

The internal server 200 may input the test data set to the training-completed artificial intelligence model and may measure an error to determine whether to activate the artificial intelligence model depending on whether a predetermined performance or higher is achieved. The internal server 200 may use the test data to the training-completed artificial intelligence model to measure the performance of the training-completed artificial intelligence model. When the performance of the training-completed artificial intelligence model is equal to or greater than a predetermined criterion, the artificial intelligence model may be activated for use in other applications.

When the performance of the training-completed artificial intelligence model is less than the predetermined criterion, the internal server 200 may deactivate and discard the artificial intelligence model. For example, the internal server 200 may determine the performance of the generated artificial intelligence model on the basis of factors, such as accuracy, precision, recall, etc. The above-described performance assessment criteria are merely examples and are not limited thereto.

In addition, the artificial intelligence model may be trained in at least one of the following schemes: supervised learning, unsupervised learning, and semi-supervised learning. Training of the artificial intelligence model is to minimize an error of output. Training of the artificial intelligence model is a process of repeatedly inputting the training data to the artificial intelligence model, calculating an error between the output and the target of the artificial intelligence model with respect to the training data, backwards propagating the error of the artificial intelligence model in a direction from the output layer to the input layer of the artificial intelligence model in order to decrease the error, and updating a weight of each node of the artificial intelligence model.

In supervised learning, each piece of training data (that is, labeled training data) labeled with a correct answer is used. In unsupervised learning, each piece of training data may not be labeled with a correct answer. That is, for example, the training data in supervised learning for data classification may be data obtained by labelling each piece of training data with category. The training data is input to the artificial intelligence model and the output (category) of the artificial intelligence model is compared with the label of the training data to calculate an error.

As another example, in unsupervised learning for data classification, training data that is input is compared with output of the artificial intelligence model to calculate an error. The calculated error is backwards propagated in a reverse direction (that is, from the output layer to the input layer) in the artificial intelligence model, and a connection weight of each of the nodes of each layer of the artificial intelligence model may be updated according to the backpropagation.

An amount of change in the updated connection weight of each node may be determined according to a learning rate. The calculation of the artificial intelligence model for the input data and the backwards propagation of the error may constitute a training cycle (epoch). Different learning rates may be applied according to the number of repetitions of the training cycle of the artificial intelligence model. For example, at the initial stage of training of the artificial intelligence model, a high learning rate is used to make the artificial intelligence model rapidly secure performance of a predetermined level and improve efficiency, and at the latter stage of training, a low learning rate is used to increase accuracy.

In training of the artificial intelligence model, the training data may be generally a subset of actual data (that is, data to be processed by using the trained artificial intelligence model). Thus, an error for the training data may decrease, but a training cycle in which an error for the actual data increases may exist. Overfitting is a phenomenon in which training with training data is excessively performed and an error for actual data increases. For example, a phenomenon in which an artificial intelligence model learning a cat while seeing a yellow cart cannot recognize cats other than a yellow cat as cats is a sort of overfitting. Overfitting may act as a cause of increasing an error of a machine learning algorithm.

In order to prevent the overfitting, various optimization methods may be used. In order to prevent the overfitting, a method of increasing training data, a regularization method, a dropout method of omitting a part of nodes of the network during the training process, and the like may be applied.

In an embodiment, a process of training the artificial intelligence model is simultaneously performed by the internal server 200, so the internal server 200 may distribute the trained artificial intelligence model into a plurality of the computing devices 100. The load generated to train the artificial intelligence model may be born by the internal server 200 instead of the computing device 100.

In step S230, the internal server 200 may provide information on the artificial intelligence model to the computing device 100. The information on the artificial intelligence model may be data or a program of the trained artificial intelligence model.

In another embodiment, in step S220′, the computing device 100 may set the information on the movement data stored in the storage 140 as training data, may use the training data to train the artificial intelligence model, and may store the trained artificial intelligence model in the storage. In this case, the computing device 100 may train the artificial intelligence model by itself instead of receiving the artificial intelligence model from the internal server 200. The computing device 100 may train the artificial intelligence model by performing above-described steps S510 and S520 in the same manner. In the description of steps S510 and S520, the subject performing steps S510 and S520 is changed from the internal server 200 to the computing device 100, so that application may be made in the same manner and a redundant description will thus be omitted.

In step S240, when the computing device 100 receives the data or program of the trained artificial intelligence model from the internal server 200 or trains and generates the artificial intelligence model by itself, the computing device 100 may store the trained artificial intelligence model in the storage 140. When there is a pre-stored artificial intelligence model, the pre-stored artificial intelligence model may be updated with a newly trained artificial intelligence model.

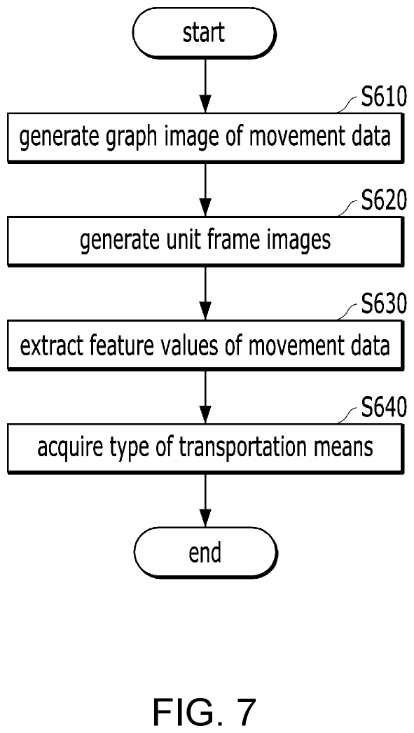

In various embodiments, in step S300 of FIG. 4 or step S310 of FIG. 5, the computing device 100 may classify a transportation means by using the artificial intelligence model trained with the movement data. Hereinafter, a method of acquiring the type of the transportation means that the user is taking will be described with reference to FIG. 7.

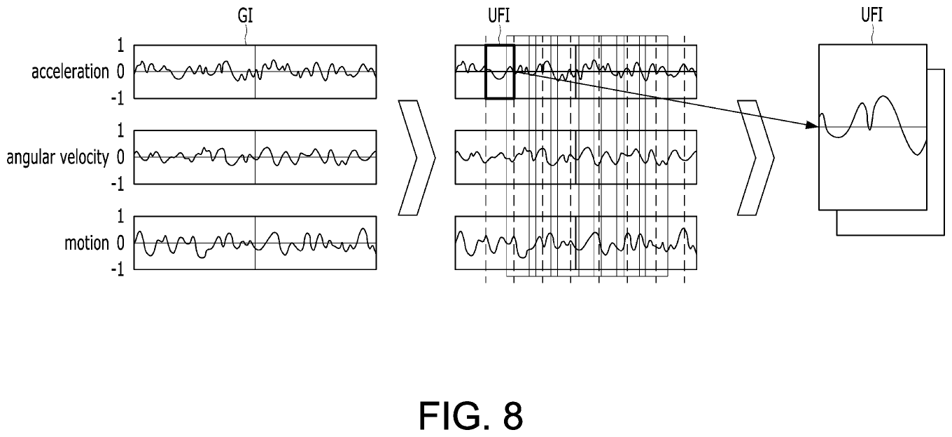

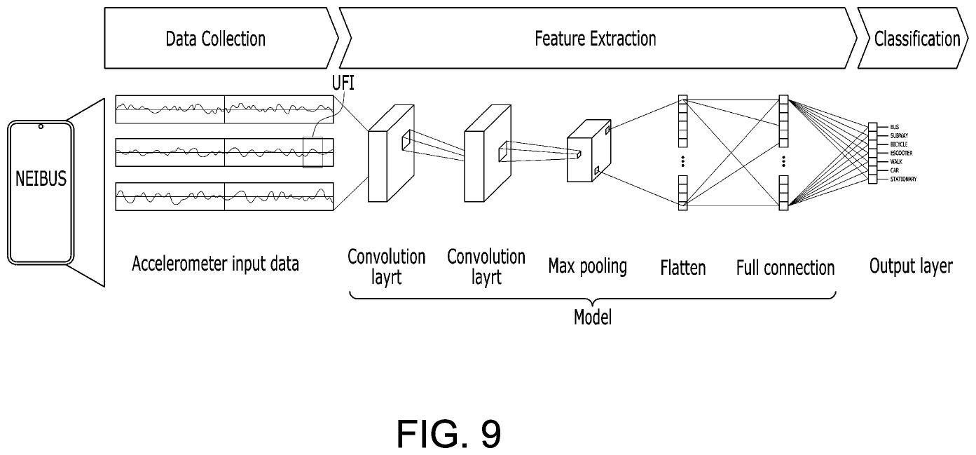

FIG. 7 is a flowchart illustrating a method of acquiring a type of a transportation means being taken by a user, in various embodiments. FIG. 8 is a diagram illustrating examples of graphs generated by an apparatus for determining a mobility user's movement pattern using artificial intelligence, in various embodiments. FIG. 9 is a diagram illustrating a concept of classifying a type of a transportation means being taken by a user, in various embodiments.

Referring to FIGS. 7 to 9, in step S610, the computing device 100 may generate a graph image GI of which one axis represents values of movement data (for example, at least one selected from the group of acceleration, angular velocity, motion, and the number of steps) with respect to the transportation means and another axis represents time when the movement data is acquired. The computing device 100 may image the movement data obtained in real time into a graph.

The computing device 100 may convert the movement data into values within a preset range and may use the values resulting from converting the movement data to generate the graph image GI. Herein, the preset range is −1 to 1, but is not limited thereto. The computing device 100 calculates probability values of any one selected from the group of acceleration, angular velocity, motion, and the number of steps, and uses the distribution of the probability values to calculate a preset approximation function. Next, the computing device 100 applies, into the approximation function, any one selected from the group of acceleration, angular velocity, motion, and the number of steps collected by the movement sensor unit 161 of the computing device 100 of the user who is taking the transportation means, thereby performing conversion into values within the range of −1 to 1. However, no limitation thereto is imposed, and the computing device 100 may use probability distribution generated in advance (for example, generated by the internal server) to convert values of the movement data into values within the range of −1 to 1.

Referring to FIG. 8, the computing device 100 may generate an image of a 2D graph with the time axis with each piece of the movement data converted into a value within the preset range (for example, a value in the range of −1 to 1). For example, the computing device 100 may generate a 2D graph showing acceleration values according to the time axis, may generate a 2D graph showing angular velocity values according to the time axis, and may generate a 2D graph showing motion values according to the time axis.

Referring to FIGS. 7 and 8, in step S620, the computing device 100 may divide the generated graph image GI on the basis of a preset time period (for example, three seconds) and generate unit frame images (UFIs). For example, computing device 100 may generate unit frame images (UFIs) by dividing the graph image by a first time interval on the time axis of the graph, and may store the unit frame images in the storage.

In various embodiments, the computing device 100 may divide graph images of respective pieces of movement data at first time intervals from the same time point with respect to the movement data collected simultaneously, and may store unit frame images (UFIs) of each piece of the movement data.

Referring to FIGS. 7 and 9, in step S630, the computing device 100 may extract feature values of the movement data.

In an embodiment, the computing device 100 may extract the feature values of the movement data by using the trained artificial intelligence model for the unit frame images of each piece of the movement data. Herein, the feature values of the movement data may refer to values that are extracted from the movement data by using the trained artificial intelligence model and include a unique feature for each transportation means.

In an embodiment, the computing device 100 may extract the feature values by using the artificial intelligence model for data values themselves of the movement data collected at a first time point that is a current time point when it is intended to determine the type of the transportation means. Alternatively, the computing device 100 may extract the feature values by using the artificial intelligence model for data values of the movement data collected at the first time point and an amount of change (for example, a difference value, an average value, a median value, etc.) in data values of the movement data collected for a predetermined period before the first time point (for example, three seconds immediately before the first time point).

In various embodiments, the computing device 100 may calculate an amount of change in the movement data by using the method below. For example, the computing device 100 may determine a first time point that is a basis time point and at least one past time point (for example, a second time point three seconds before the first time point, a third time point six seconds before the first time point, a fourth time point nine seconds before the first time point, etc.) a preset time interval before the first time point.

In various embodiments, the computing device 100 may use data values of the movement data collected at a first time point and data values of the movement data collected for a predetermined period before the first time point to set an approximation function in the form of a quadratic function.

The computing device 100 may use the set at least one approximation function to calculate a rate of change in the movement data, and may use the calculated rate of change in the movement data to calculate an amount of change in the movement data.

Referring to FIGS. 7 and 9, in step S640, the computing device 100 may use the feature values of the movement data to acquire the type of the transportation means that the user is taking. For example, the computing device 100 may use movement data and at least one feature value extracted from a graph generated on the basis of the movement data as input values of the pre-trained artificial intelligence model to calculate result data on the probability of the type of the transportation means, and may use the extracted result data to determine the type of the transportation means.

Herein, the computing device 100 may acquire the type of the transportation means by using the feature values of the movement data extracted using the unit frame images generated at first time intervals. Accordingly, the computing device 100 may use the plurality of unit frame images in chronological order to determine the type of the transportation means, thereby obtaining data on whether the transportation means has changed or time point data on change.

In various embodiments, the computing device 100 may set at least one feature value extracted using the trained artificial intelligence model as a vector value, may input the vector value to the artificial intelligence model, and may extract result data for the input vector value.

In various embodiments, a plurality of artificial intelligence models may be included. The plurality of artificial intelligence models may include a deep learning model, a random forest model, a convolutional neural network (CNN) model, a long short-term memory (LSTM) model, a recurrent CNN (R-CNN) model, etc.

In various embodiments, the computing device 100 may use one of the plurality of artificial intelligence models to extract one piece of result data on the probability of the type of the transportation means, and may use the extracted one piece of result data to determine the type of the transportation means.

In a preferred embodiment of the present disclosure, the computing device 100 may use the convolutional neural network to extract result data on the probability of the type of the transportation means, and may use the extracted result data to determine the type of the transportation means. The convolutional neural network is an unsupervised learning model and is capable of performing learning with unlabeled movement data and extracting feature values of movement data for each unit time period in real time and thus determining types of transportation means over time.

In various embodiments, the computing device 100 may use one of the plurality of artificial intelligence models to extract at least two pieces of result data on the probability of the type of the transportation means, and may use the extracted at least two pieces of result data to determine the type of the transportation means. For example, the computing device 100 may obtain a sum of results indicative of excess of 50% among the at least two pieces of result data of the artificial intelligence model and may input the sum to the artificial intelligence model for final determination, thereby determining the type of the transportation means.

In another embodiment, referring back to FIG. 5, in step S310′, the internal server 200 may classify a transportation means by using the artificial intelligence model trained with the movement data. Instead of the computing device 100, the internal server 200 may perform the method, which is shown in FIG. 7, of acquiring the type of the transportation means being taken by the user. In the description of steps S610 to S640, the subject performing steps S610 to S640 is changed from the computing device 100 to the internal server 200, so that application may be made in the same manner and a redundant description will be omitted.

In various embodiments, in step S311′ of FIG. 5, the internal server 200 may transmit information on the type of the transportation means to the computing device 100. In this case, in step S310, the computing device 100 may determine what transportation means the user is taking, on the basis of the information on the type of the transportation means received from the internal server 200.

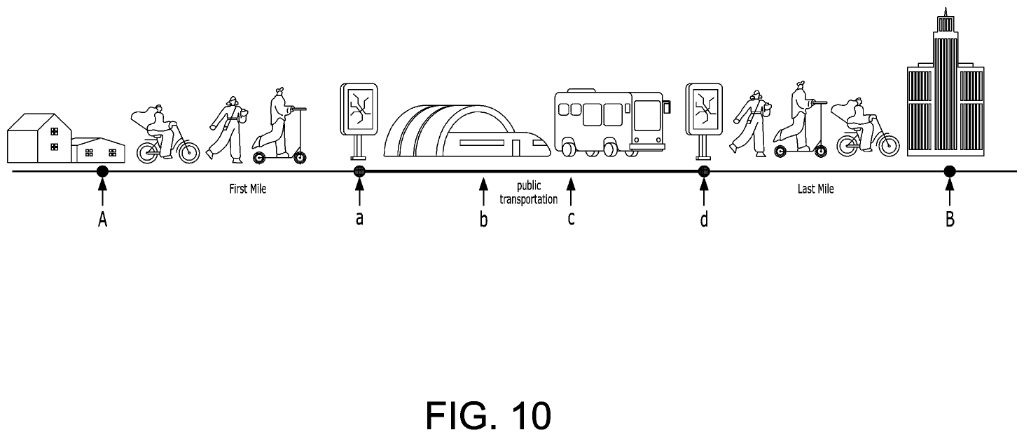

In various embodiments, in step S400 of FIG. 4 or step S410 of FIG. 5, the computing device 100 may determine a movement pattern of the user by using the acquired type of the transportation means. Hereinafter, a method of determining a user's movement pattern will be described with reference to FIGS. 10 to 13.

FIG. 10 is a diagram illustrating examples of transportation means usable for moving from point A to point B.

Referring to FIG. 10, when a user moves from point A to point B, the user may take various transportation means. Hereinafter, as an example, a description will be made assuming that a situation in which a user walks from point A to bus stop a, takes a bus from bus stop a to bus stop b, walks from bus stop b to subway station c, takes a subway from subway station c to subway station d, and walks from subway station d to point B.

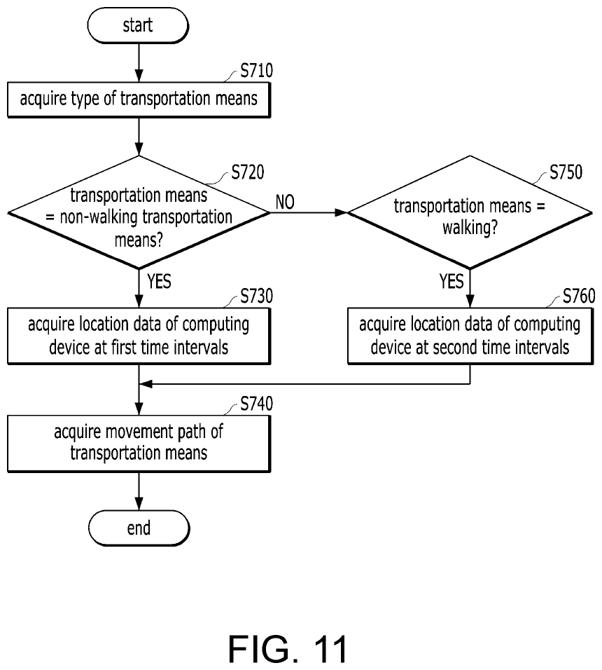

FIG. 11 is a flowchart illustrating a method of acquiring a movement path of a transportation means by using location data of a computing device as a method of determining a user's movement pattern, in various embodiments.

Referring to FIG. 11, in step S710, the computing device 100 may use a pre-trained artificial intelligence model with movement data to may acquire a type of a transportation means that the user is taking. The computing device 100 may collect the movement data at first movement time intervals, may input the collected movement data to the artificial intelligence model, and may output the type of the transportation means. For example, the first movement time interval may be several seconds or several minutes.

In step S720, the computing device 100 may determine whether the type of the transportation means has changed. For example, the computing device 100 may acquire data on whether the type of the transportation means has changed from walking to a bus, from a bus to walking, from walking to a subway, or from a subway to walking, and may acquire time point data on change.

In an embodiment, the computing device 100 may determine whether the transportation means is a non-walking transportation means. The non-walking transportation means may reach a higher speed than walking, and may include at least one of the following: a bus, a subway, a bicycle, an e-scooter, and a car. When the user is moving on a bus, the computing device 100 may determine that the transportation means the user is taking is a bus by using the movement data. Since a bus belongs to the non-walking transportation means, the computing device 100 may determine that the user is taking the non-walking transportation means.

In step S730, when the changed transportation means is the non-walking transportation means, the computing device 100 may acquire the location data of the computing device. The computing device 100 may use the location sensor 162 to acquire the location data of the user carrying the computing device. Herein, the computing device 100 may acquire the user's location data at third time intervals, but the third time interval may have a sensing period capable of minimizing the battery consumption of the computing device because of GPS.

In various embodiments, when the changed transportation means is the non-walking transportation means, the computing device 100 may change the sensing period for acquiring the location data of the computing device to acquire the location data at first time intervals. Furthermore, the computing device 100 may change the sensing period for the location data of the computing device from the third time interval to the first time interval. In the meantime, different first time intervals may be set according to the non-walking transportation means. For example, the faster the instantaneous speed of the non-walking transportation means, the shorter the first time interval is set. When the non-walking transportation means is a subway, the first time interval may be set shorter than that of the case in which the non-walking transportation means is a bus. Herein, the first time interval is set shorter than the third time interval.

When the user is not taking the non-walking transportation means, the third time interval, which is long, is set as the user's location sensing period. When the user is taking the non-walking transportation means, the first time interval, which is relatively short, is set as the location sensing period. Accordingly, the battery consumption of the computing device can be minimized.

In step S740, the computing device 100 may the movement path of the transportation means. The computing device 100 may acquire the path along which the non-walking transportation means has moved, by using the location data of the computing device acquired at first time intervals.

In various embodiments, in steps S750 and S760, when the changed transportation means is walking, the computing device 100 may change the sensing period for acquiring the location data of the computing device 100 to acquire the location data at second time intervals. The second time interval may be set relatively longer than the first time interval, and may be set relatively shorter than the third time interval. The user's displacement does not change significantly when the user walks rather than a means, such as a bus or a subway, of moving at high speed. Therefore, the user's movement path can be determined even when the sensing period for the location data is set long.

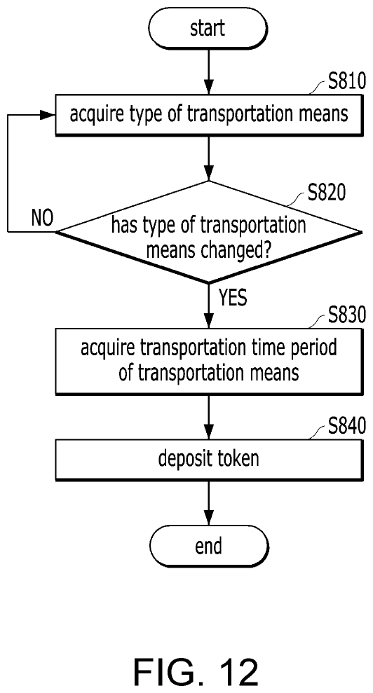

FIG. 12 is a flowchart illustrating a method of acquiring a transportation time period of a transportation means as a method of determining a user's movement pattern, in various embodiments.

Referring to FIG. 12, in step S810, the computing device 100 may use a pre-trained artificial intelligence model with movement data to may acquire the type of the transportation means that the user is taking. The computing device 100 may collect the movement data at first movement time intervals, may input the collected movement data to the artificial intelligence model, and may output the type of the transportation means.

In step S820, the computing device 100 may determine whether the type of the transportation means has changed. The computing device 100 may acquire the type of the transportation means the user is taking in real time to acquire data on whether the type of the transportation means has changed from a first transportation means to a second transportation means, and time point data on change. For example, the computing device 100 may acquire data on whether the user has boarded a bus and on the time point of boarding, data on whether the user has alighted from a bus and on the time point of alighting, data on whether the user has boarded a subway and on the time point of boarding, and data on whether the user has alighted from a subway and the time point of alighting.

In various embodiments, the computing device 100 may acquire data on the first transportation means resulting from change, the time point of change to the first transportation means, and the time point of change from the first transportation means to another transportation means, and store the same in the storage. In addition, the computing device 100 may acquire data of the transportation time period of the first transportation means on the basis of the data on the first transportation means resulting from change, the time point of change to the first transportation means, and the time point of change from the first transportation means to another transportation means.

In the meantime, the computing device 100 may acquire a transportation time period of a transportation means with respect to each of the transportation means taken between a departure point and an arrival point. For example, when a transportation means is walking, the transportation time period of the transportation means refers to a time period of the user's walking. When a transportation means is a bus, it refers to a time period of riding the bus. When a transportation means is a subway, it refers to a time period of riding the subway. When a transportation means is a car, it refers to a time period of riding the car. When a transportation means is a bicycle, it refers to a time period of riding the bicycle. When a transportation means is an e-scooter, it refers to a time period of riding the e-scooter.

In step S830, the computing device 100 may deposit tokens in the user's account according to the transportation time periods of the transportation means. The deposited tokens may be a numerical value determined according to a deposit function for each transportation means with respect to a transportation time period value.

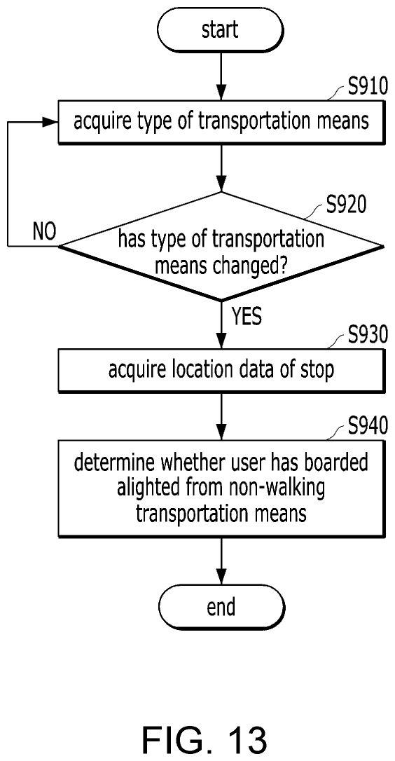

FIG. 13 is a flowchart illustrating a method of determining whether a user has boarded or alighted from a non-walking transportation means by using location data of a stop as a method of determining a user's movement pattern, in various embodiments.

Referring to FIG. 13, in step S910, the computing device 100 may use a pre-trained artificial intelligence model with movement data to may acquire the type of the transportation means that the user is taking. The computing device 100 may collect the movement data at first movement time intervals, may input the collected movement data to the artificial intelligence model, and may output the type of the transportation means.

In step S920, the computing device 100 may determine whether the type of the transportation means has changed.

In step S930, when the transportation means has changed, the computing device 100 may acquire the location data of a stop. When the transportation means has changed to a non-walking transportation means, the computing device 100 may acquire the location data of the stop of the non-walking transportation means. Location data of stops of non-walking transportation means may be stored in the storage, and is periodically updated by the internal server 200. For example, the location data of the stops of the non-walking transportation means may include coordinate values of bus stops, coordinate values of subway station, etc. Furthermore, when the transportation means has changed to a non-walking transportation means, the computing device 100 may use the location sensor 162 to acquire location data of the computing device 100.

In step S940, the computing device 100 may use either the location data of the computing device or the location data of the stop or both to determine whether the user has boarded or alighted from the non-walking transportation means. Using the location data of the computing device and the location data of the stop together acquires more accurate data on whether the user has boarded or alighted from the non-walking transportation means and the time point of boarding or alighting than using only the location data of the computing device. Furthermore, the computing device 100 may use both the location data of the computing device and the location data of the stop to acquire a movement path for the non-walking transportation means.

Referring back to FIG. 5, in various embodiments, in step S410′, the internal server 200 may use data on the classified transportation means to determine the user's movement pattern. Instead of the computing device 100, the internal server 200 may perform the method of determining the user's movement pattern described with reference to FIGS. 11 to 13. In the description of FIGS. 11 to 13, the subject performing each step is changed from the computing device 100 to the internal server 200, so that application may be made in the same manner and a redundant description will be omitted.

In various embodiments, in step S411′, the internal server 200 may transmit information on the movement pattern to the computing device 100. In this case, in step S410, the computing device 100 may acquire, on the basis of the information on the movement pattern received from the internal server 200, at least one of the following: the movement path of the non-walking transportation means that the user is taking, the transportation time period of the non-walking transportation means, information on whether the user has boarded or alighted from the non-walking transportation means, and information on the time point of boarding or alighting.

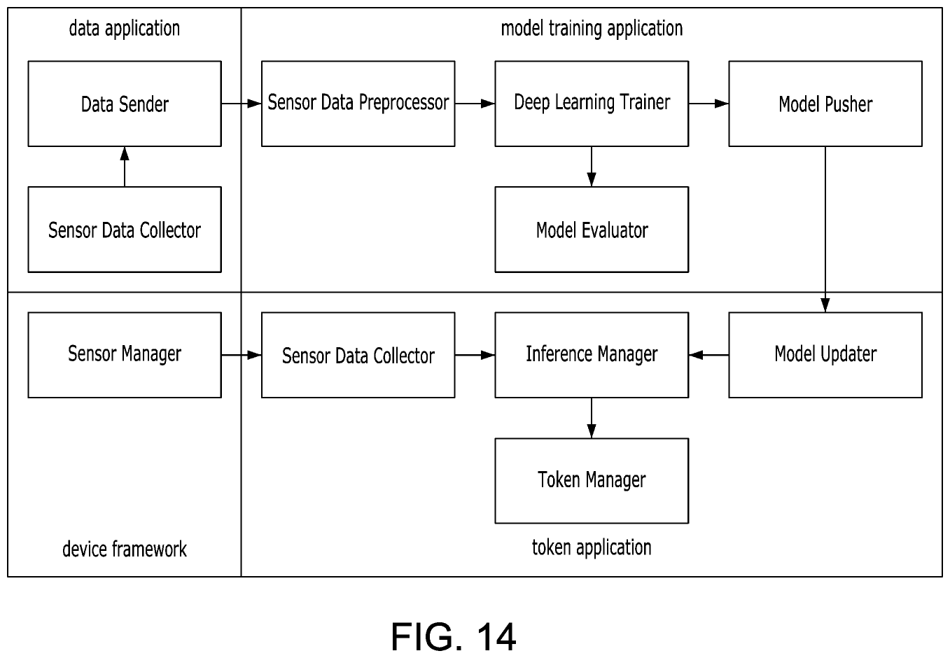

FIG. 14 is an overall conceptual diagram illustrating a system for determining a mobility user's movement pattern using artificial intelligence according to an embodiment of the present disclosure.

Referring to FIG. 14, the system for determining a mobility user's movement pattern using artificial intelligence may include: a device framework for collecting sensing data; a data application for managing data; a model training application for managing an artificial intelligence model; and a token application for classifying sensing data.

The device framework includes a sensor manager for sensing and transmitting movement data and location data of a user. The sensor manager may collect data (for example, acceleration data, angular velocity data, motion data, and step count data) sensed by the computing device 100 such as a smartphone.

The data application may include: a sensor data collector for receiving the sensing data (for example, acceleration data, angular velocity data, motion data, and step count data) from the sensor manager and storing the same; and a data sender for transmitting the collected sensing data to the server 200.

The model training application may be performed on a cloud server or the internal server 200 such as the system's own server. The model training application may include: a sensor data preprocessor for preprocessing the sensing data received from the data sender into a format appropriate for training; a deep learning trainer for training a deep learning model (for example, a convolutional neural network model) with the preprocessed training data to generate the deep learning model trained with the sensing data; a model evaluator for evaluating the trained model and making an evaluation report; and a model pusher for transmitting the trained model to a model updater.

The token application may be performed on the computing device 100 or the internal server 200. The token application may include: a sensor data collector for receiving the sensing data from the sensor manager; the model updater for receiving the trained model from the model pusher and updating an existing model; an inference manager for inferring movement pattern information of a user in real time with the model trained using the received sensing data; and a token manager for depositing, on the basis of the movement pattern information of the user, tokens determined for each transportation means.

The method for determining a mobility user's movement pattern using artificial intelligence has been described with reference to the flowcharts shown in the drawings. For a brief description, the method for determining a mobility user's movement pattern using artificial intelligence has been illustrated as a series of blocks and described, but the present disclosure is not limited to the order of the blocks and some blocks may be performed in a different order than the order shown and described in this specification or may be performed simultaneously. In addition, new blocks, not described in the specification and drawings, may be added, or some blocks may be deleted or changed.

The embodiments of the present disclosure have been provided to illustrate the present disclosure with reference to the accompanying drawings, it will be apparent to those skilled in the art that the embodiments are given by way of illustration only, and that various modifications and equivalent embodiments can be made without departing from the spirit and scope of the present disclosure. Accordingly, the true range of protection of the present disclosure should be determined by the technical spirit of the following claims.

What is claimed is:

1. A method for determining a mobility user's movement pattern using artificial intelligence, the method being performed by a computing device and comprising:
acquiring movement data of the computing device that the user taking a transportation means carries; and
acquiring a type of the transportation means by using an artificial intelligence model trained with the movement data,
wherein the movement data of the computing device includes at least one selected from a group of acceleration data, angular velocity data, motion data, and step count data.

2. The method of claim 1, wherein the transportation means includes at least one selected from a group of a bus, a subway, a bicycle, an e-scooter, a car, and walking.

3. The method of claim 1, further comprising:
after the acquiring of the movement data, transmitting the movement data to an internal server; and
receiving the artificial intelligence model trained with the movement data from the internal server.

4. The method of claim 1, further comprising:
determining whether the type of the transportation means has changed;
acquiring location data of the computing device when it is determined that the changed transportation means is a non-walking transportation means; and
acquiring a movement path of the computing device by using the location data of the computing device.

5. The method of claim 4, wherein the acquiring of the location data of the computing device when it is determined that the changed transportation means is the non-walking transportation means comprises acquiring the location data of the computing device at first time intervals.

6. The method of claim 5, wherein the acquiring of the location data of the computing device when it is determined that the changed transportation means is the non-walking transportation means further comprises acquiring the location data of the computing device at second time intervals longer than the first time intervals when it is determined that the changed transportation means is walking.

7. The method of claim 1, wherein the acquiring of the type of the transportation means by using the artificial intelligence model trained with the movement data comprises:
extracting a feature value of the movement data by using the artificial intelligence model trained with the movement data;
extracting a probability value for the type of the transportation means on the basis of the feature value of the movement data; and
acquiring the type of the transportation means on the basis of the probability value for the type of the transportation means.

8. The method of claim 7, wherein the extracting of the feature value of the movement data by using the artificial intelligence model trained with the movement data comprises:
generating a graph image of which one axis represents values of the movement data and another axis represents time when the movement data is acquired;
dividing the graph image into unit frame images on the basis of a preset time period; and
extracting the feature value of the movement data by using the trained artificial intelligence model for the unit frame images.

9. The method of claim 1, further comprising:
determining whether the type of the transportation means has changed; and
acquiring a transportation time period of each of the transportation means on the basis of a time point of changing the transportation means.

10. The method of claim 1, further comprising:
determining whether the type of the transportation means has changed;
acquiring location data of the computing device when it is determined that the changed transportation means is a non-walking transportation means;
acquiring location data of a stop of the non-walking transportation means; and
determining whether the user has boarded or alighted from the non-walking transportation means, on the basis of the location data of the computing device and the location data of the stop.

11. The method of claim 3, wherein the transmitting of the movement data to the internal server comprises transmitting the movement data, and a type value of the transportation means when the movement data is sensed to the internal server,
wherein the artificial intelligence model is trained with the movement data and the type value of the transportation means with which the movement data is labeled.

12. An apparatus for determining a mobility user's movement pattern using artificial intelligence, the apparatus comprising:
a processor;
a network interface;
a memory; and
a computer program loaded into the memory and executed by the processor,
wherein the computer program comprises:
an instruction for acquiring movement data of the user taking a transportation means; and
an instruction for acquiring a type of the transportation means by using an artificial intelligence model trained with the movement data.

13. A computer program for determining a mobility user's movement pattern using artificial intelligence, the computer program being combined with a computing device and being stored on a computer-readable recording medium to execute:
acquiring movement data of the computing device that the user taking a transportation means carries; and
acquiring a type of the transportation means by using an artificial intelligence model trained with the movement data.
